(19) United States
(12) Patent Application Publication
(10) Pub. No.: US 2012/0310799 A1
(43) Pub. Date: Dec. 6, 2012

(54) PAYROLL RECONCILIATION SYSTEMS AND METHODS

(76) Inventor: Chia-Chieh Chen, Milpitas, CA (US)

(21) Appl. No.: 13/585,834

(22) Filed: Aug. 15, 2012

Related U.S. Application Data
(63) Continuation-in-part of application No. 13/425,754, filed on Mar. 21, 2012.
Application No. 13/425,754 is a division of application No. 12/362,754, filed on Jan. 30, 2009, now Pat. No. 8,165,936.
(60) Provisional application No. 61/025,607, filed on Feb. 19, 2008.

(51) Int. Cl. G06Q 40/00

(52) U.S. Cl. 705/31

(57) ABSTRACT

A method of payroll reconciliation comprising providing a first set of employee payroll data relating to at least one paycheck previously issued to an employee; preparing an adjusting check using the first set of employee payroll data on a paycheck system comprising a client interface comprising a plurality of editable fields; allowing a user to edit data on the plurality of the editable fields, wherein the data on the plurality of the editable fields for the adjusting check comprises cumulative earnings and taxes; storing in a computer readable medium the data for the adjusting check; and preparing an employee paycheck using the paycheck system.

### PRIORITY CLAIM

This is a continuation-in-part patent application of pending U.S. patent application Ser. No. 13/425,754 filed Mar. 21, 2012. U.S. patent application Ser. No. 13/425,754 and this application claims the benefit of U.S. patent application Ser. No. 12/362,754 filed Jan. 30, 2009, which is now U.S. Pat. No. 8,165,936. U.S. patent application Ser. No. 12/362,754, U.S. patent application Ser. No. 13/425,754, and this application claim the benefit of U.S. Provisional Patent Application No. 61/025,607 filed Feb. 19, 2008 entitled PAYROLL SYSTEM AND METHOD.

### BACKGROUND

1. Field of the Invention

The present invention relates to a payroll systems and methods, and in particular systems and methods for conducting payroll reconciliations and adjustments.

2. Discussion of the Related Art

Complicated and Labor Intensive Payroll Setup in Conventional Systems

As shown in FIG. 1A, traditional payroll systems include a payroll setup phase 100a. In the payroll setup phase, traditional payroll systems typically require an initial entry of information about the company or employer 102 and information about an employee 104 that may not change from pay period to pay period. For instance, information about an employer may include the employer name, employer address, employer tax identification, and information related to payroll related benefits offered by the employer, such as health benefits or retirement plan matching benefits. Information about an employee may include the employee name, employee address, employee marital status, number of tax deductions claimed by the employee, and benefits information such as health care or retirement plan contributions. From this information, the step of payroll setup may be 106 performed. If there are no new employees since the last payroll was executed, preparation for payroll processing 107, 109b includes prior payroll reconciliation 108 and achieving a state ready for payroll processing 110.

If there is a new employee to be added since the last payroll was executed, setup of new employee payroll information must be performed in order to prepare the system for payroll processing 110. Setup of new employee payroll information may include the steps of entering a new employee record 105, employee setup 104 of the new employee, payroll setup 106 of the new employee, payroll reconciliation 108 and achieving a state ready for payroll processing 110. These steps may further require additional sub-steps (not depicted), such as the sub-steps required to perform the step of payroll reconciliation 108. As shown in FIG. 1B, payroll processing 100b is ready to begin after payroll setup reaches the ready for payroll processing state 110. Payroll processing steps include making time card/earning entries for each employee 112, generating and printing paychecks 114, accounting for payroll tax deposits 116 and payroll reporting (including preparation of US IRS form 941 and the like) 118.

Lack of Flexibility in Conventional Payroll Systems

In traditional payroll systems, much of the information for an employee's paycheck is unable to be edited by a user or administrator for the employer. The information related to the paycheck, including paycheck amount, statutory deductions, and miscellaneous withholdings or payments, are calculated from the setup information entered into the system. Therefore, an employer is not given the ability to correct paycheck information in the event of a payroll error, or if the circumstances required modification of the employee's paycheck or statutory deductions. Furthermore, in traditional paycheck management systems, an employer may not be able to generate a paycheck without performing each of the steps discussed in FIGS. 1A and 1B, which can be a very lengthy and time-consuming process. For example, if an employer wanted to generate a paycheck for a new employee for extra work performed by the employee, or if the employer simply wanted to generate a paycheck where setting up an entire payroll record for the payee was not convenient or necessary, the employer still had to perform all of the steps of payroll setup as discussed above.

Inefficient and Often Inaccurate Payroll Reconciliation With Conventional Payroll Systems

The steps typically required for payroll reconciliation may include entering the new employee's prior paycheck information, adjusting the new employee's payroll information to be compatible with the current payroll system if imported from another system employer, and adjusting the new employee's statutory deductions. Without proper performance of these steps, an employer runs the risk of generating inaccurate future paychecks for the new employee until the end of the year. Payroll reconciliation 108 in traditional payroll systems may require an excessive plurality of steps to incorporate a new employee's payroll information or correct errors or make adjustments to an employee's payroll information. For example, if a new employee is entered into the payroll system for an employer during the middle of the tax calendar year, the employer may be required to enter all of the employee's previous payroll information into the employer's system so that the employee's previous paychecks and various withholdings is calculated into the employee's paychecks moving forward. In traditional payroll systems, this may require the employer to recreate substantially all of the employee's paychecks to date for that year, which may be extremely time consuming. Additionally, as described above, conventional payroll systems may not provide much flexibility in terms of allowing users to enter the appropriate data, including paycheck amount, statutory deductions, and miscellaneous withholdings or payments. If the users are not allowed to enter the appropriate data, this makes the entire payroll reconciliation process highly susceptible to error. The traditional approach may also result in erroneous deductions and paycheck amounts in the future, as well as erroneous tax records for the employer.

In summary, traditional payroll systems may be extremely rigid and require a lengthy setup procedure before any paychecks can be generated. They may require an excessive plurality of steps which must be performed in a certain order. Such systems are not user friendly, require the assistance of human technical/customer support during at least the setup phase, and are inflexible, particularly in payroll reconciliation 108 and modification of payroll information. Efficient reconciliation of an employee's cumulative payroll information is desired to assimilate the employee's payroll with the current employer's payroll management system or adjustment of errors for correct management of the employee's payroll in the future.

Furthermore, it is desirable to allow authorized users to modify, in real time, an employee's. payroll information such as pay rate, statutory deductions, and miscellaneous adjustments, in addition to the ability to generate paystubs and paychecks based on said modified information for the efficient and effective management of an employer's payroll.

### SUMMARY

The present invention provides a method of payroll reconciliation comprising providing a first set of employee payroll data, the first set, of employee payroll data relating to at least one paycheck previously issued to an employee; preparing an adjusting check using the first set of employee payroll data on a paycheck system, the paycheck system comprising a client interface comprising a plurality of editable fields, the plurality of editable fields comprising an employee's earnings, pay cycle, and taxes deductions from the employee's paycheck; a client computer configured to access the client interface, the client computer comprising an input device configured to enter data into the plurality of editable fields; a database of tax formulas for calculating the tax deductions from the employee's paycheck; and a processor in communication with the database of tax formulas and the client interface, the processor configured to determine the tax deductions from the employee's paycheck and display them on the plurality of editable fields; allowing a user to edit data on the plurality of the editable fields, wherein the data on the plurality of the editable fields for the adjusting check comprises cumulative earnings and taxes; storing in a computer readable medium the data for the adjusting check; and preparing an employee paycheck using the paycheck system, the step of preparing the employee paycheck comprising entering the employee's earnings and pay cycle using the input device.

The present invention also includes a system for generating a paycheck comprising: a client computer configured to be used by a user for creating a paycheck for an employee, the client computer comprising an input device configured to allow the user to input the employee's earnings, number of tax exemptions, and pay cycle; a database of tax formulas for calculating the taxes to be withheld from the employee's paycheck; a processor in communication with the database of tax formulas, the processor being configured to determine the taxes to be withheld from the employee's paycheck; and a man-machine interface that is accessible by the client computer and the processor, the man-machine interface comprising a plurality of data fields pertaining to the employee's earnings, number of tax exemptions, pay cycle, and the taxes to be withheld from the employee's paycheck, wherein the plurality of data fields are editable and are configured to allow the user to modify the data in the data fields.

The present invention also includes a payroll management system comprising a data processor which is configured to receive payroll data and process payroll related to an employer and at least one employee; a client computer connected to the data processor; and a man-machine interface configured to be displayed on the client: computer, the man-machine interface comprising: a plurality of data entry fields, the plurality of data entry fields comprising an employee pay cycle field where an employee's pay cycle can be entered, a field for a paycheck date where the date when the employee's paycheck will be issued can be entered, and an earnings field where an employee's gross earnings can be entered; a plurality of tax fields, each of the plurality of tax fields configured to show a tax value; and a calculate icon configured to execute a calculation command to determine each of the plurality of taxes to withhold from the employee's paycheck based on the data provided in the plurality of the data entry fields.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1a shows a prior art payroll method.

FIG. 1b shows a prior art payroll processing method.

FIG. 2 shows an embodiment of a payroll system in accordance with the present invention.

FIG. 3 shows an embodiment of a payroll method of the present invention.

FIG. 4 shows another embodiment of a payroll method of the present invention.

FIG. 5 shows yet another embodiment of a payroll method in accordance with the present invention.

FIG. 6 shows a man-machine interface implementation that may be utilized in implementing the payroll methods of the present invention.

FIG. 7 shows another embodiment of a payroll method in accordance with the present invention.

FIG. 8 shows a man-machine interface implementation that may be utilized in the embodiment of the payroll method of FIG. 7.

FIG. 9 shows yet another embodiment of a payroll system of the present invention.

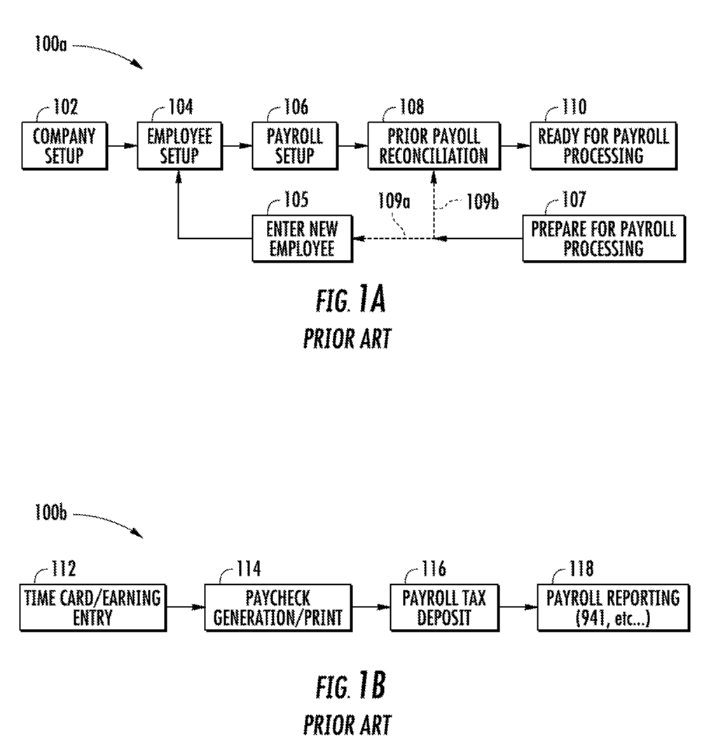

### DETAILED DESCRIPTION OF THE PREFERRED EMBODIMENTS

The disclosure provided in the following pages describes examples of some embodiments of the invention. The designs, figures, and description are non-limiting examples of certain embodiments of the invention. For example, other embodiments of the disclosed systems and methods may or may not include the features described herein. Moreover, disclosed advantages and benefits may apply to only certain embodiments of the invention and should not be used to limit the disclosed inventions.

The present invention relates to a paycheck-centric payroll systems and methods for generating, accumulating, modifying, and reporting on payroll information including payroll deductions. The term “paycheck-centric” shall be used to describe a system which includes a data processor which may be initially void of any information about particular employers and employees, where a first paycheck request activity may initiate a process which makes this information available to the data processor for storage and use in later operations. Thereafter, subsequent paycheck request activities may make available updated information to the data processor for storage and use in later operations.

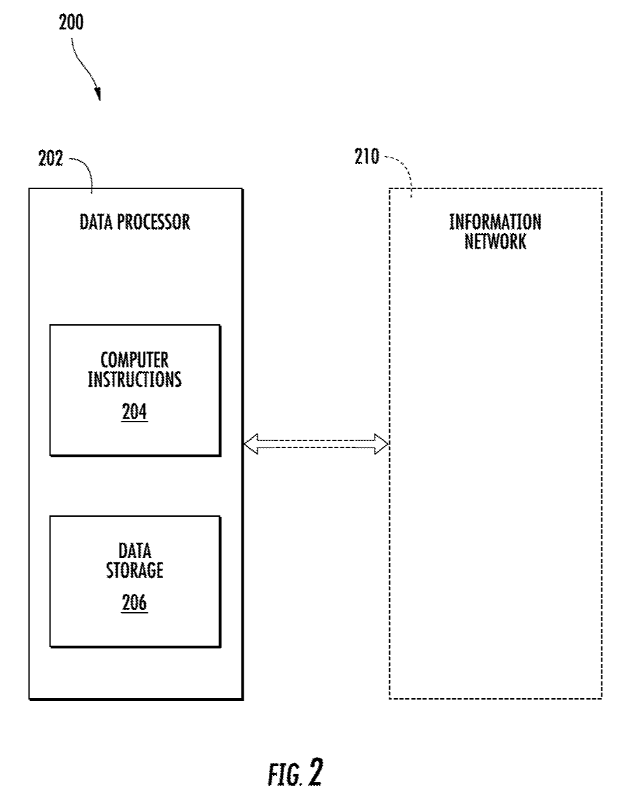

The present invention further includes various embodiments of payroll reconciliation systems and methods as well as payroll adjustment systems and methods. Referring now to FIG. 2, a system in accordance with the present invention 200 includes a data processor 202 with computer instructions 204 and data storage 206. The data processor may he interconnected with an information network 210. As used in this specification, data processor means a device for processing data including a computer. The term “computer” means one or more digital computers, workstations, or the like; and, the terms “connections/interconnections” refer to direct or indirect connections.

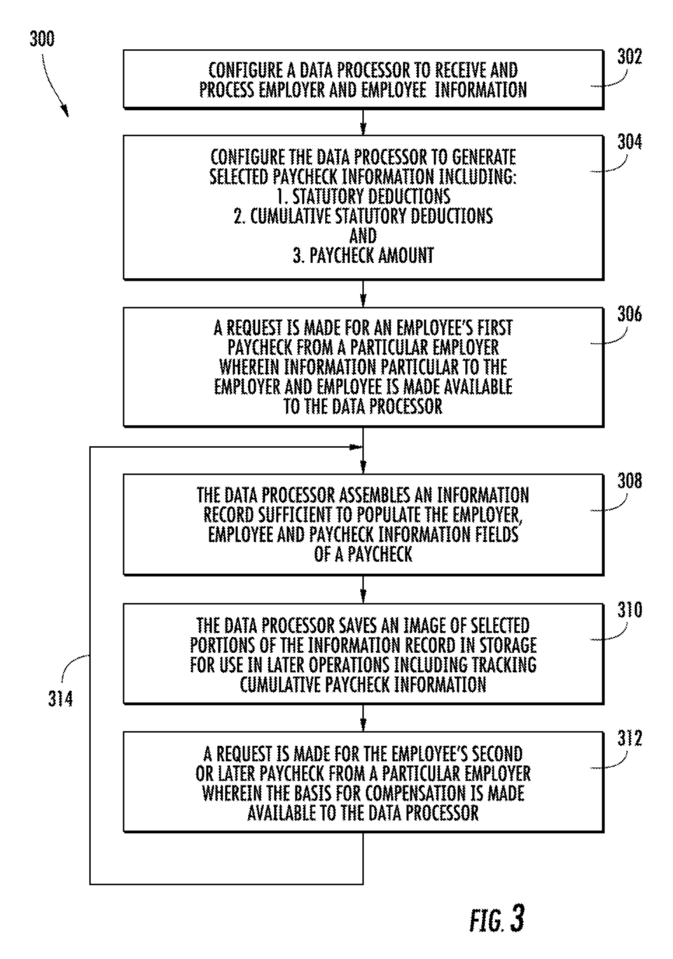

FIG. 3 shows a flowchart of a payroll management method in accordance with the present invention 300. In the method, a data processor is preferably configured to receive and process employer and employee information 302. The data processor is also configured to generate selected paycheck information including statutory deductions, such as federal income tax, social security tax, medicare tax, state income tax, disability insurance and similar statutory amounts, cumulative statutory deductions and paycheck amount. As persons of ordinary skill in the art will understand, some embodiments may implement other deductions, such as pre-tax and after tax deductions, or non-statutory deductions aimed at, for example, funding an employee savings plan.

When an employee's first paycheck from a particular employer is requested, information particular to the employer and employee is preferably made available to the data processor by the check requestor 306. The data processor may allow the check requestor to enter compensation information such as hours worked and the hourly rate. The paycheck request results in the data processor assembling a paycheck information record sufficient to populate the employer, employee, and paycheck information fields of a paycheck 308. Selected portions of the paycheck information record are saved by the data processor for tracking cumulative paycheck information 310. The information record may be stored in the payroll information database and the statutory deductions database.

When an employee's second or later paycheck from a particular employer is requested, the paycheck requestor makes the compensation basis available to the data processor 312 and the method returns to step 308 to assemble another paycheck information record. To the extent that deductions made from prior checks relate to the current tax year, period and accumulated tax year deductions are preferably available for printing checks, employer/employee reports, and government tax forms such as form IRS 941. Employer's Quarterly Financial Tax Return.

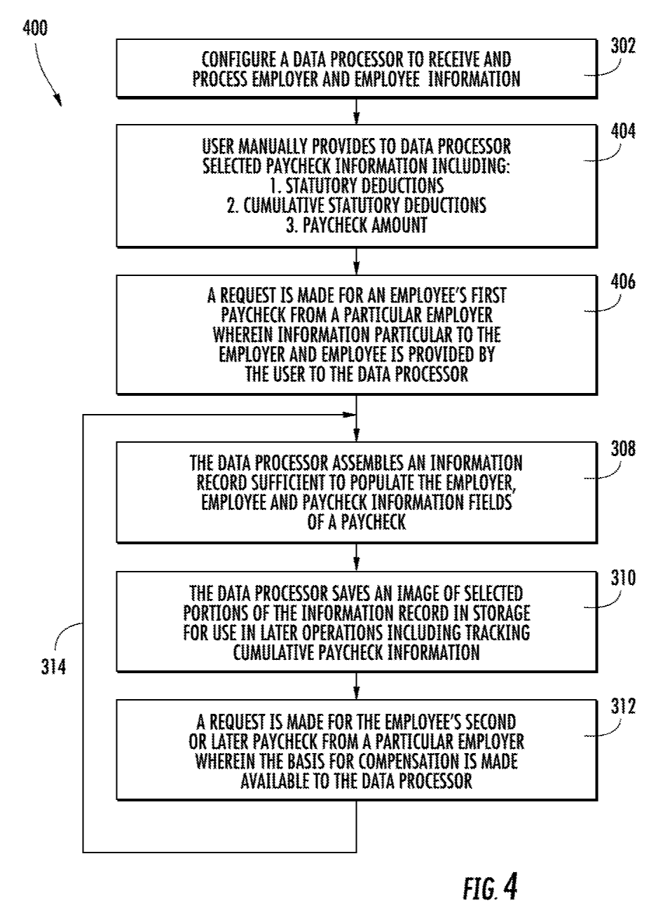

FIG. 4 shows a flowchart of another embodiment of a paycheck-centric payroll management method 400 comprising some of the steps of the embodiment discussed in FIG. 3, Wherein entry of payroll and paycheck information is manually performed by the user. In this embodiment, a user is able to provide to the data processor selected paycheck information 404 including statutory deductions (such as federal income tax, social security tax, medicare tax, state income tax, disability insurance and similar statutory amounts), cumulative statutory deductions and paycheck amount. In addition, the user is preferably able to provide information of the employee and employer payroll information 406. In some embodiments, it is the user's input of the employee and employer payroll information 406 that first makes this information available to the data processor for storage and reuse in later operations.

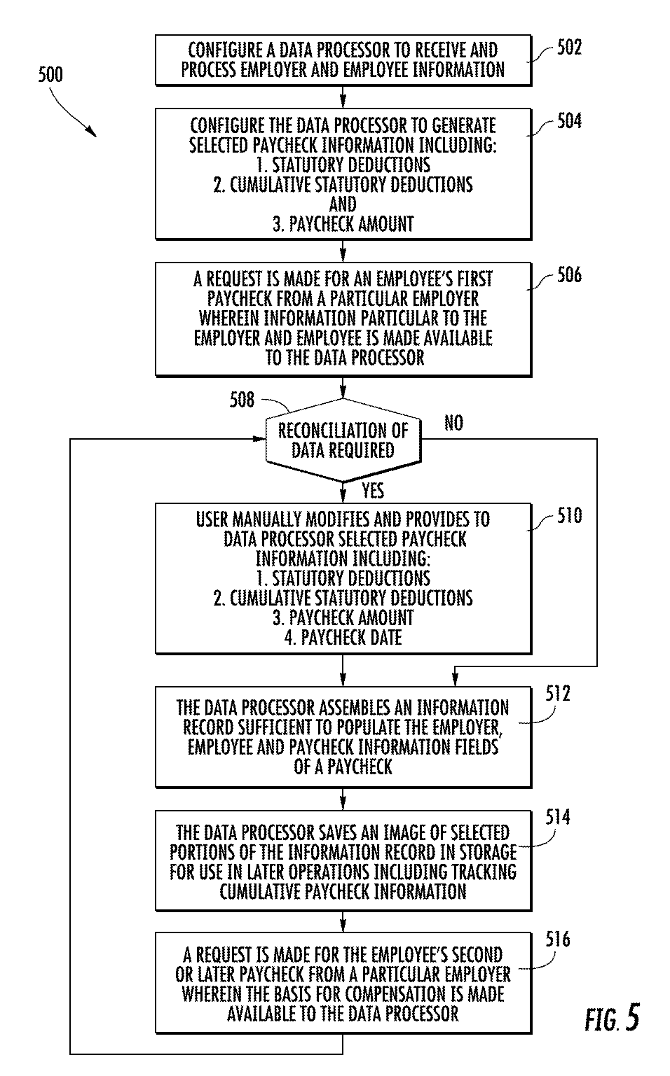

FIG. 5 shows a flowchart of another embodiment of an improved payroll management method in accordance with the present invention 500. In the method, a data processor is configured to receive and process employer and employee information 502. The data. processor is also configured to generate selected paycheck information 504 including statutory deductions (such as federal income tax, social security tax, medicare tax, state income tax, disability insurance and similar statutory amounts), cumulative statutory deductions and paycheck amount.

In an embodiment, prior to any paychecks having been requested from the system, the data processor may be void of any information about particular employers and employees, or the information may require reconciliation to correct errors or update the prior information (Step 508). This may occur when a new employee is entered into the system and no prior payroll. information has been provided for that particular employee. It may also occur when information about a particular employer or employee contains errors or requires updating due to out of date information, updated calculations, or updated record keeping methods. If such reconciliation 508 of information is required, the user is able to manually enter or modify such information for the paycheck 510. Such user generated entries or modifications may include an employee's prior payroll information, statutory deductions, cumulative statutory deductions, paycheck date, and paycheck amounts.

After a user performs reconciliation of an employee's payroll information, or if no such reconciliation is required, the paycheck request results in the data processor assembling a paycheck information record sufficient to populate the employer, employee, and paycheck information fields of a paycheck 512. Selected portions of the paycheck information record are saved by the data processor for tracking cumulative paycheck information 514. By storing the cumulative paycheck information 514, the data processor may provide for accurate and efficient reconciliation of the employee's payroll information.

As in the other embodiments, when an employee's second or later paycheck from a particular employer is requested 516, the user determines whether a reconciliation of the employee's payroll information is required 508. If required, a user is then again able to manually enter or modify said employee's paycheck information including statutory deductions, cumulative statutory deductions, and paycheck amount 510, if necessary. If reconciliation 508 of the employee's payroll information is not required, the data processor may proceed to assemble an information record sufficient to populate the various data 512 required to save selected portions of the information record 514.

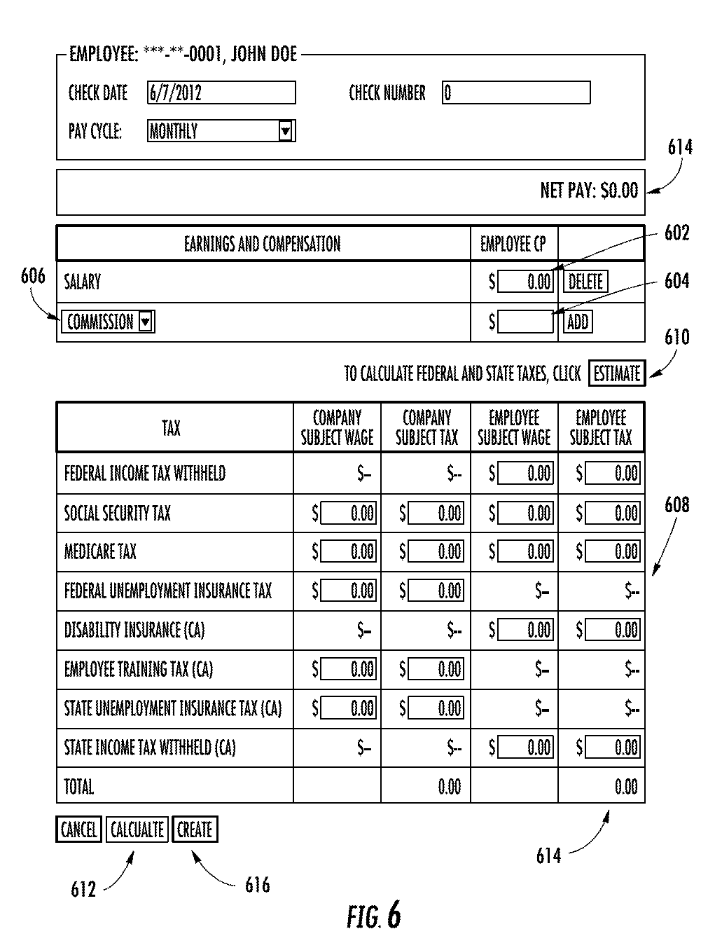

FIG. 6 is a depiction of an exemplary embodiment of a man-machine interface (“interface”) implemented to allow the user to interact with the embodiment of the present invention if reconciliation of an employee's payroll information is required, as discussed in FIG. 5 above. In this interface, an editable payment data field 602 is provided to allow the user to enter gross paycheck amount information for an employee to the data processor. In another embodiment, the interface may further include an additional payment data field 604 for the user to enter additional gross amounts to be paid to the employee for a single paycheck. This embodiment may further include a categorization data field 606 for the user to enter a categorization of the amount entered into the additional payment data field 604. For example, if a paycheck is to be generated for an employee for a gross salary amount of $5,000 with an additional payment of $500 in bonus pay, a user may utilize the interface depicted in FIG. 6 to enter paycheck information to the data processor by entering “5000” in the payment data field 602, and “500” in the additional payment data field 604. The user may categorize the additional payment data field 604 value by entering the type of additional payment into the categorization data field 606; in this example, the user would enter “Bonus.” The interface may further be configured to accept other values in the categorization data field 606 such as “Commission,” “Vacation,” “Overtime,” or “Sick Pay.”

The interface depicted in FIG. 6 may further include editable deduction data fields 608 for the user to enter statutory deductions and cumulative statutory deductions. Alternatively, the interface may include a button 610 for the user to indicate to the data processor to initiate deduction estimate calculations for all statutory deductions and cumulative deductions instead of manually entering the deductions one by one. If the estimate calculation process is initiated by the user, the data processor may perform deduction estimate calculations using previously stored payroll data or stored statutory deduction calculation tables, and insert these deduction estimate values in the deduction data fields 608. In the present invention, the deduction data fields 608 preferably remain fully editable to the user even after the user initiates deduction estimate calculations by the data processor. This allows the user further flexibility to edit and modify an employee's paycheck and paystub information in real time if required. This flexibility may further allow a user to perform accurate and efficient reconciliation of an employee's payroll record by entering information to the data processor, payroll information database, and statutory deductions database related to the employee's year-to-date payroll information.

The interface of FIG. 6 may further include a calculate button 612 for the user to initiate a final calculation to output the final paycheck amount 614 based on the paycheck and deduction information entered by the user or estimated by the data processor. The interface may further include a create button 616 to generate in real time and print, an employee's paycheck and paystub based on the information entered by the user or estimated by the data processor. Generation of an employee's paycheck and paystub information may result in the data processor saving an image of the employee payroll information entered into the interface depicted in FIG. 6 for use in later operations including tracking cumulative paycheck information.

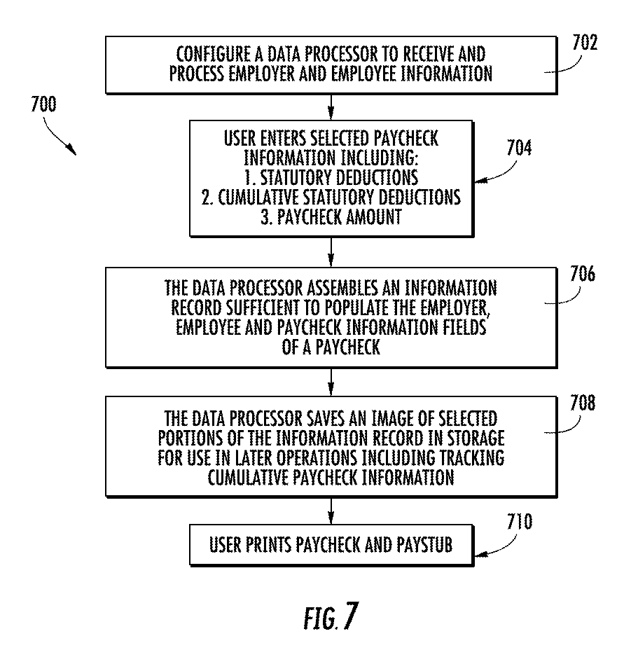

FIG. 7 shows a flowchart of another embodiment of a paycheck-centric payroll management method in accordance with the present invention 700. In the method, a data processor is configured to receive and process employer and employee information 702. In this embodiment, a user is able to generate a paycheck and paystub without requiring prior entered payroll information or payroll data reconciliation. This embodiment includes a step in which the user enters selected paycheck information 704 including statutory deductions, cumulative statutory deductions, and paycheck amount. This step allows the user to manually enter information related to the employee's paycheck and payroll without requiring the user to execute processes such as payroll setup or payroll reconciliation. Following the user's entry of information 704, the embodiment may further include a step 706 in which the data processor assembles an information record sufficient to populate the employer, employee and paycheck information fields of a paycheck to be generated and printed by the user. Step 706 may allow for future use of the manually entered information by the user for additional paychecks or for payroll reconciliation. Step 708 may include the data processor storing data contained in the information record in the payroll information database and the statutory deductions database. Storage of the data in the payroll information database may create or populate an employee information record in the payroll information database. Alternatively, the payroll information database may be configured to receive and store this information by replacing existing employee payroll information with the information record entered by the user. Similarly, storage of the data in the statutory deductions database may create, populate, or replace the information contained in the database particular to the specific employee. This embodiment may further include a step 710 in which the user prints the employee's paycheck and paystub for payment and record keeping.

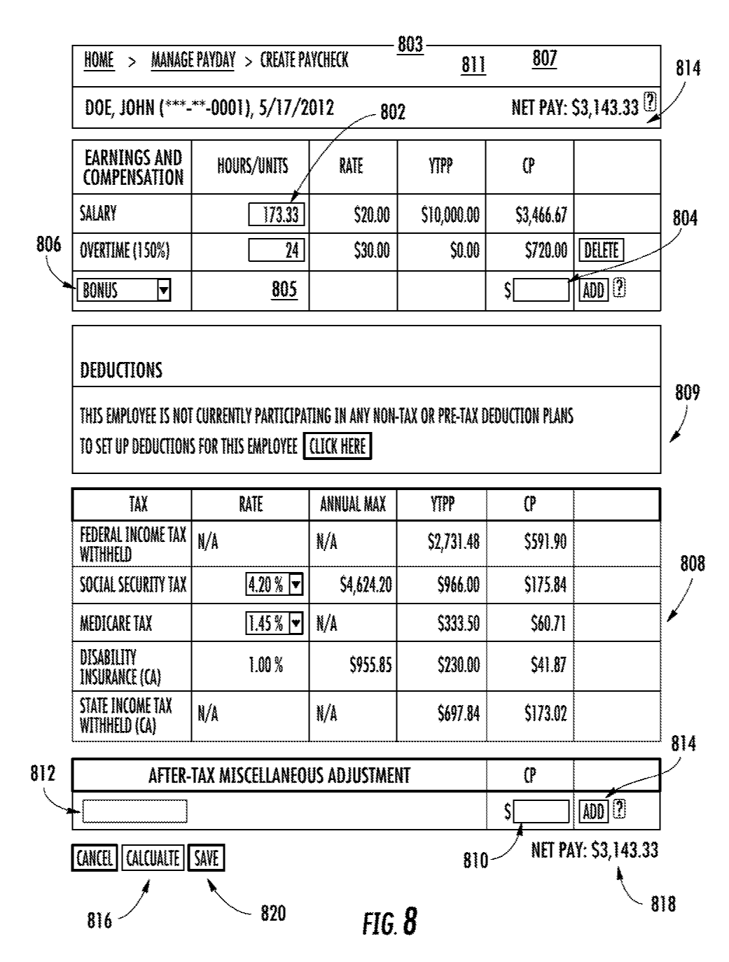

FIG. 8 is a depiction of an exemplary embodiment of a user interface which may be implemented to allow the user to do a payroll reconciliation and create and issue a paycheck for an employee. The interface preferably provides a pre-established salary and overtime rates of the employee 803 such that when the user enters the number of hours or units worked on the basic salary hours field 802 and optionally the number of overtime hours or units worked on the overtime hours field 805, the data processor calculates the current pay, which is preferably listed on the Current Pay (CP) column 807. The CP column 807 preferably reports the amount for the salary and overtime separately. The interface preferably also provides a calculation of the amount: paid to the employee from the beginning of the tax year to the previous pay period (YTPP), which may be listed on the YTPP column 811. The YTPP column 811 preferably also reports the YTPP amounts for the salary and overtime separately.

The interface may further include an additional payment data field 804 for the user to enter gross additional amounts to be paid to the employee for a single paycheck. A categorization data field 806 may further be provided for the user to enter a categorization of the amount entered into the additional payment data field 804. For example, if a paycheck is to be generated for an employee with an additional payment of $500 in bonus pay, a user may utilize the interface depicted in FIG. 8 to enter paycheck information to the data processor by entering “500” in the additional payment data field 804. The user may categorize the additional payment data field 804 value by entering the type of additional payment into the categorization data field 806; in this example, the user would enter “Bonus.” The interface may further he configured to accept other values in the categorization data field 806 such as “Commission,” “Vacation,” “Overtime,” or “Sick Pay.”

The interface depicted in FIG. 8 may further include pre-calculated pre-tax deduction fields 809 and statutory deduction fields 808 based on the employee's statutory deductions status, which may be influenced by the employee's marital status, tax bracket, and number of dependents. One or more of the statutory deduction fields 808 may be editable to the user to allow for modification of the employee's paycheck amount and deduction withholdings, such as the social security tax rate and the medical tax rate. Alternatively, the interface may include a button (not depicted) for the user to indicate to the data processor to initiate deduction estimate calculations for all statutory deductions and cumulative deductions.

The interface may further include data input fields for miscellaneous adjustments to be calculated into the employee's paycheck after statutory deductions, also referred to as “after-tax miscellaneous adjustments.” To enter after-tax miscellaneous adjustments, the interface may include an input field 810 for the user to enter the amount to be deducted or added to the employee's paycheck amount. The interface may further provide an input field 812 for the user to enter a description of the deduction or addition to the paycheck amount, as well as a button 814 to incorporate the deduction or addition to the employee's calculated final paycheck amount 818. For example, if an employee's wages are to be garnished for court ordered child support payments in an amount of $500 per paycheck, the user may enter “500.00” into the input field 810, and enter the text description “Child Support Garnishment” into input field 812. The user may then enter the miscellaneous adjustment by clicking the “Add” button 814, which submits the adjustment information to the data processor, resulting in a recalculated final payment amount 818 for the current paycheck. Other examples of after-tax miscellaneous adjustments may include a loan taken out by the employee against the employee's retirement account, contributions to a non-employer sponsored retirement savings account. IRS wage garnishments, or any other after-tax adjustments to the employee's wages.

The interface of FIG. 8 may further include a calculate button 816 for the user to initiate a final calculation to output the final paycheck amount 818 based on the paycheck and deduction information entered by the user. The interface may further include a save button 820 to generate in real time and print an employee's paycheck and paystub based on the information entered by the user. The embodiment may further comprise the step of the data processor saving an image of the employee payroll information entered into die interface depicted in FIG. 8 for use in later operations including tracking cumulative paycheck information. This step may include the data processor storing certain information entered into the interface to the payroll information database and statutory deductions database for the particular employee, including the information entered by the user for after-tax miscellaneous adjustments, if any. After a user has completed inputting and saving the employee's paycheck information, the interface may further include a button (not depicted) to create a paycheck and paystub for the employee, and send the information to a printer (not depicted) for printing.

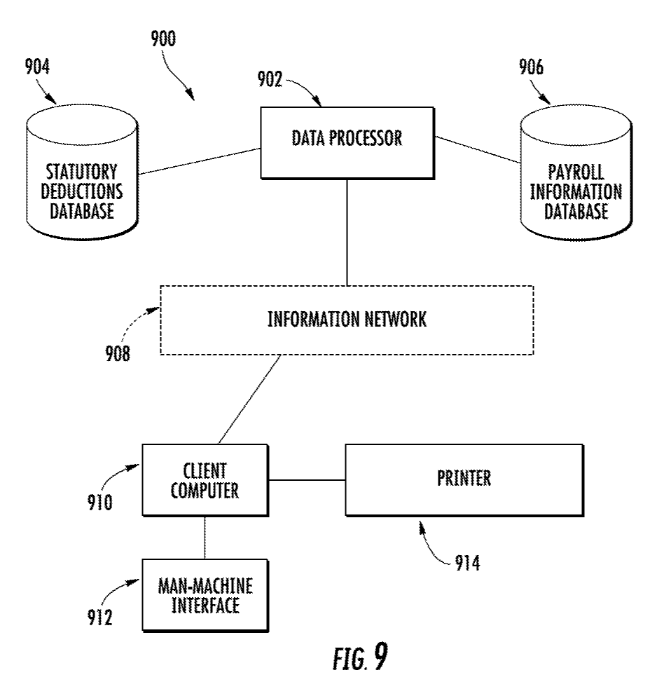

FIG. 9 shows an exemplary networked embodiment of the present invention 900. Here, a data processor 901 is provided and is connected to a statutory deductions database 902 and a payroll information database 903. The data processor 901 is further connected to an information network such as a local, wide-area or global (Internet) information network 904, which interconnects the data processor to at least one client computer 910. In an alternate embodiment, the data processor 902 is connected to the statutory deductions database 904 and the payroll information database 906 via the information network 908.

At least one client computer 910 may be connected via the information network to the data processor 902. The client computer may provide a man-machine interface 912 to the user via a display and input mechanisms for the user (not shown) such that the user is able to interact with the interface as well as enter in manually entered information. The client computer 910 may be further connected to a printer 914, configured to produce paychecks and paystubs for employees created by the data processor, as well as other payroll related printouts such as payroll reports and tax documentation. The client computer 910 may also connect to the information network 908 to make direct payroll deposits to the employees' banks and to electronically submit payroll reports and tax documentation.

In another embodiment, the printer 914 may be connected to the information network 908. In this embodiment, the printer 914 may receive a signal from the data processor 902 or the client computer 910. As the printer 914 may be physically located anywhere on the network, an instruction to print a check from an information record of the payroll information database 906 need not result in a check being printed local to either of the data processors, but can be used to print the check at any location where the printer 914 is attached to the network.

While various embodiments of the present invention have been described above, it should be understood that they have been presented by way of example only, and not limitation. It will be apparent to those skilled in the art that various changes in the form and details can he made without departing from the spirit and scope of the invention. As such, the breadth and scope of the present invention should not be limited by the above-described exemplary embodiments, but should be defined only in accordance with the following claims and equivalents thereof

What is claimed is:

1. A method of payroll reconciliation, the method comprising:
a. providing a first set of employee payroll data, the first set of employee payroll data relating to at least one paycheck previously issued to an employee;
b. preparing an adjusting check using the first set of employee payroll data on a paycheck system, the paycheck system comprising:
i. a client interface comprising a plurality of editable fields, the plurality of editable fields comprising an employee's earnings, pay cycle, and taxes deductions from the employee's paycheck;
ii. a client computer configured to access the client interface, the client computer comprising an input device configured to enter data into the plurality of editable fields;
iii. a database of tax formulas for calculating the tax deductions from the employee's paycheck; and
iv. a processor in communication with the database of tax formulas and the client interface, the processor configured to determine the tax deductions from the employee's paycheck and display them on the plurality of editable fields;
c. allowing a user to edit data on the plurality of the editable fields, wherein the data on the plurality of the editable fields for the adjusting check comprises cumulative earnings and taxes;
d. storing in a computer readable medium the data for the adjusting check; and
e. preparing an employee paycheck using the paycheck system, the step of preparing the employee paycheck comprising entering the employee's earnings and pay cycle using the input device.

2. The method of claim 1, wherein the step of preparing an employee paycheck further comprises allowing the data on the plurality of editable fields to be changed by the user.

3. The method of claim 1, wherein the processor takes into account the cumulative earnings and taxes when determining a net pay for the employee paycheck.

4. The method of claim 1, where in the first set of employee payroll data was generated by a first payroll system and the step of preparing the employee paycheck is conducted on a second payroll system.

5. The method of claim 4, wherein the first payroll system belongs to a first employer and a second payroll system belongs to a second employer.

6. The method of claim 1 further comprising preparing an adjusting paycheck for every quarter's worth of employee payroll data.

7. The method of claim 1 further comprising preparing a single adjusting paycheck using the first set of payroll data, the first set of payroll data spanning over various quarters of pay periods.

8. A system for generating a paycheck, the system comprising:
a. a client computer configured to be used by a user for creating a paycheck for an employee, the client computer comprising an input device configured to allow the user to input the employee's earnings, number of tax exemptions, and pay cycle;
b. a database of tax formulas for calculating the taxes to be withheld from the employee's paycheck;
c. a processor in communication with the database of tax formulas, the processor being configured to determine the taxes to be withheld from the employee's paycheck; and
d. a man-machine interface that is accessible by the client computer and the processor, the man-machine interface comprising a plurality of data fields pertaining to the employee's earnings, number of tax exemptions, pay cycle, and the taxes to be withheld from the employee's paycheck, wherein the plurality of data fields are editable and are configured to allow the user to modify the data in the data fields.

9. The system of claim 8, further comprising an icon displayed on the man-machine interface, which upon activation is configured to execute a command to the processor to calculate the employee's net pay without printing a paycheck and display on the plurality of data fields the taxes to be withheld from the employee's paycheck.

10. The system of claim 8, wherein the processor is configured to determine the taxes to be paid by the employer, the taxes to be paid by the employer being configured to be displayed on the man-machine interface.

11. The system of claim 8, further comprising a computer readable storage device configured to store the employee's earnings, number of tax exemptions, pay cycle, and the taxes to be withheld from the employee's paycheck.

12. The system of claim 11, wherein the processor is configured to determine cumulative earnings and taxes of the employee and store the cumulative earnings and taxes in the computer readable storage device.

13. A payroll management system comprising:
a. a data processor which is configured to receive payroll data and process payroll related to an employer and at least one employee;
b. a client computer connected to the data processor; and
c. a man-machine interface configured to be displayed on the client computer, the man-machine interface comprising:
i. a plurality of data entry fields, the plurality of data entry fields comprising an employee pay cycle field where an employee's pay cycle can be entered, a field for a paycheck date where the date when the employee's paycheck will be issued can be entered, and an earnings field where an employee's gross earnings can be entered;
ii. a plurality of tax fields, each of the plurality of tax fields configured to show a tax value determined by the data processor; and
iii. a calculate icon configured to execute a calculation command to determine each of the plurality of taxes to withhold from the employee's paycheck based on the data provided in the plurality of the data entry fields.

14. The system of claim 13 further comprising a print icon configured to execute a command to print, a paycheck.

15. The system of claim 13 further comprising a save icon configured to execute a command to generate an employee's paycheck

16. The system of claim 13 further comprising a database connected to the data processor, said database configured to store cumulative payroll history of at least one employee.

17. The system of claim 13, wherein the man-machine interface is configured to receive statutory deductions input from the user for an employee's paycheck.

18. The system of claim 13, wherein the data processor is further configured to calculate estimated statutory deductions for the employee's paycheck and the man-machine interface is further configured to display said estimated statutory deductions for the employee's paycheck to the user where said estimated statutory deductions are editable by the user.
